(19) United States
(12) Patent Application Publication
(10) Pub. No.: US 2009/0221744 A1
(43) Pub. Date: Sep. 3, 2009

(54) PROCESS FOR PREPARING A HIGH-COHESION PSA

(75) Inventors: Sabine Thormeier, Hamburg (DE); Franziska Zmarsly, Hamburg (DE); Christian Kreft, Hamburg (DE); Axel Burmeister, Buchholz (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 12/104,474

(22) Filed: Apr. 17, 2008

(30) Foreign Application Priority Data
Mar. 3, 2008 (DE) 10 2008 012 185.1

(51) Int. Cl. C08L 7/00

(52) U.S. Cl. 524/575.5

(57) ABSTRACT

A process is presented for the preparation of a high-cohesion non-thermoplastic pressure-sensitive adhesive (PSA) on the basis of elastomers, in which neither a solvent nor thermoplastic additives are used and yet thermal breakdown during compounding is kept low. This is achieved through the addition of a vaporizable process agent which is introduced into the adhesive after the constituents have been premixed and which undergoes flash vaporization therein, thereby quenching the adhesive. Furthermore, the use of water to cool the adhesive is proposed, and the high-cohesion PSA thus produced, and also a pressure-sensitive adhesive tape with an adhesive of this kind, are presented.

The invention relates to a process for preparing a high-cohesion non-thermoplastic pressure-sensitive adhesive (PSA) by mixing, in a first mixing step, constituents of the PSA comprising at least one elastomer by means of a first mixing assembly, at a first assembly temperature of the first mixing assembly, to give a premix and homogeneously mixing, in a second mixing step, the constituents of the premix by means of a second mixing assembly, at a second assembly temperature of the second mixing assembly. The invention further relates to the high-cohesion PSA preparable by this process and also to a pressure-sensitively adhesive, substantially two-dimensional element with such a PSA.

The significance of PSAs has increased sharply in recent years. PSAs are adhesives which even under a relatively weak application pressure permit durable bonding with the bond substrate and after use can be detached again from the substrate substantially without residue. The bondability of the adhesives is based on their adhesive properties, and the redetachability is based on their cohesive properties.

Adhesion is typically identified as the physical effect that holds two contacted phases together at their interface on the basis of intermolecular interactions occurring at said interface. The adhesion therefore determines the clinging of the adhesive to the substrate surface that can be determined as tack and as bond strength. To exert a deliberate influence on the adhesion of the adhesive, the adhesive is frequently admixed with plasticizers and/or bond strength enhancer resins (referred to as tackifiers).

Cohesion is typically identified as the physical effect that results in a compound or composition holding together internally on the basis of intermolecular and/or intramolecular interactions. The forces of cohesion therefore determine the thickness and fluidity of the adhesive, which can be determined, for instance, as viscosity and as holding power. In order deliberately to increase the cohesion of an adhesive, it is frequently subjected to additional crosslinking, for which the adhesive is admixed with reactive (and hence crosslinkable) constituents or other chemical crosslinkers and/or is subjected to an ionizing radiation aftertreatment.

The technical properties of a PSA are determined primarily by the relationship between the adhesive and cohesive properties. Thus for certain applications, for example, it is important that the adhesives used be of high cohesion, i.e. possess a particularly strong internal holding-together.

As PSAs it is possible for instance to use those adhesives which possess thermoplastic properties. Besides these there also exist non-thermoplastic PSAs. The latter are typically mixtures of at least one polymer which is dimensionally stable and elastically deformable at room temperature (a so-called elastomer) with further constituents which are added in order to influence the properties of the overall mixture (the so-called compound) in a desired way. PSAs of this kind are typically prepared by mixing the individual components with one another in the course of what is known as compounding. Simultaneously with or subsequent to this blending, the preparation of the PSAs may necessitate additional chemical reactions, such as an aftercrosslinking of the applied adhesive for the purpose of raising the viscosity.

Non-thermoplastic PSAs can be obtained and used for coating in processes in which the respective PSAs are in solution in a solvent which is removed during or after the coating operation. This produces adhesive systems which, as a result of the solvent, are of low viscosity on processing yet have a high viscosity in the end product. The use of solvent-based processing methods of this kind, however, necessitates additional operating steps, such as the dissolution of the polymers in the solvent or the stripping of the solvent from the end product, for instance, and is therefore disadvantageous.

It is for these reasons that solvent-free processes have been developed in which the blending and the application of the adhesive take place without assistance of a solvent. Thus, for instance, adhesives comprising reactive polymers can be used, where a non-thermoplastic reactive polymer, which is not fully crosslinked and therefore has a sufficiently low viscosity for processing, is mixed with adjuvants, applied to a suitable carrier or the substrate, and lastly subjected to aftercrosslinking. Without aftercrosslinking, the cohesion of a conventional non-thermoplastic PSA of this kind is low. This is disadvantageous, since such adhesives frequently cannot be redetached from the substrate without residue, meaning that there are many applications for which such low-viscosity PSAs cannot be used. It is necessary, therefore, to subject the PSA to a concluding aftercrosslinking reaction following its application.

Instead of this in addition PSAs based on non-thermoplastic polymers can also be prepared solventlessly by way of the solventless mixing of the individual constituents of the adhesive without a subsequent aftercrosslinking step. As a consequence of the higher viscosity of the polymers to be used for this purpose, this necessitates the selection of a suitable mixing assembly. The constituents of the adhesive are supplied to the mixing assembly generally in liquid form or in solid form, in the latter case preferably as individual pieces such as granules or pellets, for example.

The mixing of the individual constituents therefore necessitates the use of mixing assemblies which permit intense commixing in conjunction with a high mixing performance. Particularly in view of the high viscosity of the non-thermoplastic constituents, it is common for this purpose to have recourse to internal mixers or extruders, such as to twin-screw extruders or planetary roller extruders, in order to be able to apply the high shearing energies that are necessary for the homogeneous commixing of the adhesive.

The introduction of the high shearing energies into the high-viscosity mixture results in an increase in the temperature of the mixture, which can lead in turn to a partial thermal breakdown of the polymers and to an associated decrease in the average chain length and hence also in the average molecular weight. This effect is manifested with particular severity in the case of non-thermoplastic elastomers with unsaturated functions in the main chain, as in the case of natural rubbers, for example.

A breakdown of this kind constitutes an unwanted, uncontrolled side reaction, referred to as degradation. In the case of degradation, the chain breakdown and the accompanying breakdown products, which remain in the adhesive, have an influence—typically adverse—on the properties and capabilities of the polymer mixture, such as its ageing stability and temperature stability.

And yet thermal breakdown can also be employed deliberately in order to lower the viscosity of a mixture in a desired way. This is the case, for instance, with what is known as mastication. With this breakdown of rubber, carried out deliberately, the reaction parameters (such as the viscosity, shearing stress, the mandated temperature of the material, and also the composition of the material and of the surrounding atmosphere) are controlled to achieve controlled breakdown of the polymers. In order to improve the regulation it is possible where appropriate to add further chemical auxiliaries to the adhesive, known as masticating agents or peptizers. Within the rubber industry, such mastication is employed in order—for instance—to facilitate the integration of further adjuvants. Owing to the partial breakdown of the rubber in the course of mastication, it is frequently followed by aftercrosslinking of the adhesive, in order to achieve the PSA cohesion that is ultimately required.

The processes described above are known in wide diversity. Thus WO 94 11175, WO 95 25774, WO 97 07963 and also U.S. Pat. No. 5,539,033 and U.S. Pat. No. 5,550,175 describe the preparation of non-thermoplastic PSAs based on elastomeric rubbers, in each case using twin-screw extruders in which homogeneous PSA mixtures are obtained by means of mastication of the rubber and subsequent gradual addition of the individual adjuvants, followed by a concluding electron-beam crosslinking operation.

EP 1 326 939 describes a method of processing adhesives based on non-thermoplastic hydrocarbon elastomers that adds thermoplastic additives as processing aids to the mixture in order to lower the viscosity and hence likewise to reduce the temperature of the mixture which is established therein as a consequence of the respective viscosity. The aim there is to counter breakdown of the elastomer and at the same time to improve the homogeneity and quality of the mixture and of the coating obtained from it. With that process there is no need for mastication.

EP 1 056 584 further discloses a method of solventless continuous preparation of PSAs on the basis of non-thermoplastic elastomers that is based critically on the use of a planetary roller extruder as a mixing assembly. Such planetary roller extruders have been known for many years and were first employed in the processing of thermoplastic polymers such as polyvinyl chloride (PVC), where they were used primarily for the charging of downstream units such as calenders or roll mills. As a consequence of the intense commixing within the planetary roller extruder, it combines a short residence time with a narrow residence-time spectrum and a frequent renewal of surface area, resulting in rapid exchange of material and heat exchange, thereby allowing the energy introduced into the polymer by way of internal friction processes to be removed rapidly and effectively. On the basis of these properties, planetary roller extruders are now also employed for compounding operations where there is a focus on particularly gentle and temperature-controlled operation.

In the process EP 1 056 584 describes, the use of a planetary roller extruder means that it is possible even for non-thermoplastic elastomers, and even without the addition to the mixture of viscosity-reducing adjuvants such as plasticizers or thermoplastic additives, to forgo mastication, thereby making it possible to reduce the extent of chain breakdown and hence to prepare high-cohesion adhesives even without aftercrosslinking.

Although the two last-mentioned processes do not implement the mastication step that is otherwise customary within the rubber industry, there is even here a degradation-induced change in the adhesive in the course of the mixing of the individual constituents, the conveying of the blended adhesive and the application of the adhesive.

In order to reduce the consequences of any degradation occurring during the blending of the adhesive, the adhesive can be mixed in an inert atmosphere under inert gas (referred to as inertization). This allows severe oxygen-induced breakdown to be prevented.

The advantageous effect of an inertization is illustrated as follows using an example mixture: the mixing of an adhesive composed of 40% by weight natural rubber, the same fraction of hydrocarbon resin (having a melting point of about +100° C.), 19% by weight calcium carbonate and 1% by weight sterically hindered phenol antioxidant in an oxygen-free atmosphere (under nitrogen) results in the composition having a complex viscosity of approximately 200 000 Pa*s (determined in an oscillation viscometer at 0.1 rad/s and 110° C.) and a temperature of approximately 180° C., whereas in an oxygen-containing atmosphere (under air) a substantially lower temperature of 140° C. and a significantly lower viscosity of approximately 100 000 Pa*s (likewise determined at 0.1 rad/s and 110° C.) are observed for the composition.

The higher viscosity on processing in oxygen-free atmosphere shows that, under these conditions, the average length of the polymer chains is greater than in the case of blending in an oxygen-containing atmosphere. As a consequence of the greater average chain length it is necessary for the mixing assembly to provide a higher mixing performance when the mixtures are processed, in order to be able to apply the higher shearing energy needed to mix the adhesive. As a result of internal friction, the shearing energy is converted within the adhesive to heat, resulting in an increase in the temperature of the composition. These results therefore allow the conclusion, indirectly, that processing in an oxygen-containing atmosphere must have been accompanied at least by a strong partial thermal breakdown of the polymer chains as part of degradation processes.

Degradation processes of this kind can be observed for virtually all non-thermoplastic PSA systems based on elastomers. In order to be able to ensure sufficiently high cohesion in systems of that kind as well, such adhesives are subjected, where appropriate, to aftercrosslinking following application to the carrier or directly to the substrate, in accordance with the desired profile of requirements, in the course, for example, of a concluding electron beam crosslinking or chemical crosslinking procedure.

As already set out above, chemical aftercrosslinking of constituents present in the adhesive that are not yet in fully crosslinked form and thus constitute reactive constituents of the adhesive are crosslinked in a concluding crosslinking step after the adhesive has been applied. The aftercrosslinking reaction can be initiated thermally by heating the adhesive to a temperature above the crosslinking temperature of the respective reactive system. In the case of phenolic resins as reactive systems, for example, significant crosslinking begins above temperatures of around 130° C.

As shown by a comparison of the crosslinking temperature of 130° C. with the typical composition temperatures of 140° C. or even 180° C. that come about when the non-thermoplastic adhesive is blended solventlessly and without a mastication step, crosslinking temperature and composition temperature have the same order of magnitude. Therefore, in order to prevent a considerable fraction of the reactive system crosslinking even during blending, the composition temperature must be kept as low as possible. This necessitates precise monitoring of the operating regime, something which, however, it is not possible to achieve sufficiently with the methods known at present.

It was an object of the present invention, therefore, to provide a process for preparing a high-cohesion PSA that allows a monitored operating regime during blending, without the use of solvents or of additives that remain in the adhesive.

This object is achieved in accordance with the invention by a process of the type specified at the outset wherein the first assembly temperature and the temperature of the premix at the first assembly temperature are higher than the second assembly temperature, and wherein, furthermore, the premix is quenched between the first mixing step and the second mixing step by the addition thereto of a process agent whose boiling temperature is lower than the first assembly temperature.

The process can be employed for preparing high-cohesion non-thermoplastic pressure-sensitive adhesives based on elastomers. A high-cohesion pressure-sensitive adhesive is any PSA which has a high viscosity even without aftercrosslinking—in other words, in the non-crosslinked state. A high viscosity is considered to be a complex viscosity of more than 20 000 Pa*s, more particularly of more than 50 000 Pa*s, and in the strict sense of more than 80 000 Pa*s (determined in each case with an oscillation viscometer at 0.1 rad/s and 110° C.). It will be appreciated that this does not rule out the subjection of a high-viscosity adhesive of this kind, following its application to a substrate or carrier, to a concluding aftercrosslinking reaction, in order to increase further the viscosity which is already high from the outset.

As a base component (base constituent) non-thermoplastic PSAs of this kind comprise at least one not-exclusively-thermoplastic elastomer. Not-exclusively-thermoplastic elastomers of this kind are, for example, all non-thermoplastic elastomers, in other words elastomers which do not themselves have thermoplastic properties, such as a high molecular mass rubber such as, for example, a natural rubber.

Furthermore, not-exclusively-thermoplastic elastomers may likewise be those elastomers which are only partly thermoplastic, i.e., for instance, block copolymers which include at least one polymer block which on its own (that is, as a homopolymer) does not have thermoplastic characteristics. As an example of such polymers mention may be made, for instance, of styrene-isoprene-styrene (SIS) block copolymers or styrene-butadiene-styrene (SBS) block copolymers, which besides thermoplastic polystyrene blocks also include non-thermoplastic polyisoprene or polybutadiene blocks, respectively.

With the process of the invention it is possible to carry out solvent-free processing in principle of all non-thermoplastic PSAs which are already known and have been described in the literature, more particularly of those having self-adhesive properties. It is particularly advantageous, however, if the non-thermoplastic PSA is a rubber-based adhesive containing at least one non-thermoplastic elastomer that includes at least one rubber selected from the group consisting of natural rubbers and synthetic rubbers. It is beneficial here if the base component of the PSA is a non-thermoplastic elastomer selected from the group consisting of natural rubbers and synthetic rubbers, or is a mixture (referred to as a blend) of natural rubbers and/or synthetic rubbers. The process of the invention is outstandingly suitable for the gentle preparation of rubber-based PSAs of this kind, since with these systems a disruptive degradation is effectively reduced to a particular degree.

As a natural rubber it is possible in principle to employ all suitable natural rubbers; they include, for instance, natural rubbers in all available quality grades, for example crepe, RSS, ADS, TSR or CV types, which can be selected in accordance with the required purity and the requisite viscosity.

As a synthetic rubber it is possible in principle to use all suitable synthetic rubbers, examples being randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate (EVA) copolymers, polyurethanes, silicone rubbers and/or mixtures thereof, without wishing unnecessarily to restrict the selection by the enumeration of possible examples.

Additionally, and with preference, it is possible for the adhesive to have as a base component one or more non-rubberlike elastomers, for which purpose mention may be made at this point, as representatives, of polyacrylates or of the merely partly thermoplastic elastomers, for example styrene-isoprene-styrene (SIS) block copolymers and styrene-butadiene-styrene (SBS) block copolymers.

Besides the not-exclusively-thermoplastic elastomers as a base component it is also of course possible for such PSAs to contain thermoplastic adjuvants.

In the preparation of such adhesives, the not-exclusively-thermoplastic elastomers are mixed as part of a compounding procedure in a first mixing step, where appropriate with further constituents. Suitable, optional further constituents include all of the additives that are suitable and customary for this purpose, examples being plasticizers, fillers, nucleators, expandants, compounding agents, ageing inhibitors and/or bond strength modifier additives.

As plasticizers it is possible to use all of the plasticizing substances that are known from adhesive technology. They include, for example, paraffinic and naphthenic oils, (functionalized) oligomers such as oligobutadienes or oligoisoprenes, liquid nitrile rubbers, liquid terpene resins, vegetable and animal oils and fats, phthalates, functionalized acrylates and the like.

As bond strength modifier additives it is possible without exception to use all such additives which are already known and have been described in the literature, such as bond strength enhancer resins (“tackifier resins”). Mention may be made, as representatives, of rosins, their disproportionated, hydrogenated, polymerized and/or esterified derivatives and salts, aliphatic and aromatic hydrocarbon resins, terpene resins and terpene-phenolic resins. They can be used alone or in any desired combinations of these and further resins in order to adjust the properties of the resulting adhesive in accordance with requirements. Reference may expressly be made to the depiction of the relevant state of the art in the “Handbook of Pressure Sensitive Adhesive Technology” by Donatas Satas (van Nostrand, 1989).

For the purpose of mixing it is possible to use all suitable mixing assemblies, more particularly those which permit a high mixing energy for intense mixing of the constituents of the mixture in conjunction with high internal shearing forces, examples being extruders such as twin-screw extruders and, more particularly, planetary roller extruders. Through the use of high-performance assemblies of this kind it is possible to keep the commixing time particularly short. In this way, any degradation that may occur in the first mixing step is slight, and so there is no significant breakdown of the not-exclusively-thermoplastic elastomer.

As planetary roller extruders it is possible, for example, to use all typical and suitable planetary roller extruders. They are available in sizes and designs that vary from manufacturer to manufacturer; thus typical diameters for roller cylinders are situated within a range from 70 mm to 400 mm and are selected in accordance with the desired throughput.

Planetary roller extruders typically have a filling section and a compounding section. The filling section frequently contains a conveying screw, to which all of the components of the mixture—more particularly its solid components—are metered continuously or quasi-continuously. The conveying screw conveys the material into the compounding section. The part of the filling section that contains the conveying screw is preferably cooled, in order to counteract the clinging of material to the outside of the conveying screw.

Functionally the most important section of the planetary roller extruder is the compounding section. It typically contains a driven central spindle and a plurality of planetary spindles which revolve around the central spindle within one or more roller cylinders with internal helical gearing. The rotational speed of the central spindle (and hence also the peripheral speed of the planetary spindles) can be varied and is therefore an important parameter for the control of the mixing operation.

The components to be mixed are circulated between the central spindle and the planetary spindles and also, where appropriate, between the planetary spindles and the helical gearing of the roller cylinder, the material being dispersed to form a homogeneous compound under the action of shearing energy in conjunction with external heating.

The number of planetary spindles revolving in each roller cylinder can be adapted to the requirements of the particular operation. The number of spindles influences the free volume within the planetary roller extruder and also the residence time of the material, and also determines the size of the surface area available for heat exchange and material exchange. By way of the shearing energy which can be introduced in this way, furthermore, the number of planetary spindles affects the outcome of compounding. Given a constant roller-cylinder diameter, the homogenizing performance and dispersing performance improve and also the product throughput is higher as the number of planetary spindles goes up.

The maximum number of planetary spindles which can be installed between the central spindle and the roller cylinder is dependent on the diameter of the roller cylinder and on the diameter of the planetary spindles used. When using relatively large roller diameters (of the kind needed, for instance, for obtaining production-scale throughput rates) or when using a relatively small diameter for the planetary spindles, consequently, the roller cylinders can be equipped with a relatively large number of planetary spindles. For a roller diameter of 70 mm, there is typically a maximum of seven planetary spindles used, whereas, for a roller diameter of 200 mm, there may be, for example, ten planetary spindles and, in the case of a roller diameter of 400 mm, 24 planetary spindles, for example, provided.

In addition there are also other constructions of planetary roller extruders that can likewise be used for realizing the process of the invention. Thus, for example, the planetary roller extruder may be designed without a conveying screw section, so that the material is introduced directly between the central spindle and the planetary spindles into the extruder space.

All in all, planetary roller extruders offer the advantage of particularly intense and gentle mixing of the constituents of the adhesive, with the consequence that these assemblies may be mentioned in first place for the realization of the process of the invention.

For the first mixing step, the constituents of the PSA are introduced simultaneously or successively into the first mixing assembly and then combined with one another. Their introduction may take place continuously or discontinuously. The constituents are preferably each introduced in the form of a singularized bulk product, such as in the form of pellets or granules; these forms may be protected by an additional inert release agent from sticking in the reservoir vessel—using talc, for example. In the case of a continuous process, the addition takes place with monitoring of the respective amount introduced, in a volumetric control procedure or by means of a belt weigher, for instance. In the course of the first mixing step, the not-exclusively-thermoplastic elastomer and, where appropriate, the further constituents, such as resins and/or fillers, are broken down, producing a premix in which the constituents of the adhesive are initially present in coarse division but may occasionally already be in finely divided form.

In order to ensure a precise operating regime, the first mixing assembly is heated to a fixed first assembly temperature. In view of the high viscosity of the mixture, and as a result of the shearing forces that occur in the interior of the mixture, additional heat energy is released, with the consequence that the temperature of the premix that comes about at the first assembly temperature is higher than the first assembly temperature.

In the second mixing step the premix is then further homogenized in the second mixing assembly. For this purpose the second mixing assembly is heated to a second assembly temperature which is lower than the first assembly temperature, in order to reduce the occurrence of degradation processes.

As the second mixing assembly it is possible to use all suitable mixing assemblies, more particularly mixing assemblies having a high mixing performance, examples being extruders such as twin-screw extruders and more particularly planetary roller extruders. High-performance mixing assemblies of this kind offer the advantage that they allow intense mixing to be obtained within a short time, meaning on the one hand that the process agent can be incorporated into the premix with particular rapidity and can therefore also cool the premix particularly quickly. On the other hand it means that the complete homogenization of the adhesive can be accelerated, which reduces the occurrence of further breakdown processes.

In terms of apparatus, the second mixing assembly may be separate from or connected to the first mixing assembly or may even be identical to it; in the case of continuous mixing, for example, it may be realized as different subregions or mixing zones of a planetary roller extruder.

After the second mixing step, the constituents of the adhesive are homogeneously mixed and are therefore, at least at a macroscopic level, uniformly divided and in single-phase form. This does not rule out the possibility that at microscopic level there may be inhomogeneities in the adhesive, such as inhomogeneities of the kind which come about in the course of a microphase separation process.

Particularly advantageous results are achievable if the first assembly temperature is selected from a range from +130° C. to +180° C. and the second assembly temperature is selected from a range from +70° C. to +140° C. Operating conditions of this kind on the one hand allow sufficiently good preliminary commixing in the first mixing assembly and, at the same time, acceptable homogenization in the second mixing assembly, with the extent of any degradation processes being able to be minimized. Accordingly the particular combination of ranges for the assembly temperatures represents an optimum with which it is possible to realize a particularly gentle process regime after the process agent has been added.

In accordance with the invention the temperature of the premix at the first assembly temperature is higher than the second assembly temperature; in other words, between the first mixing step and the second mixing step, the premix is cooled. Cooling is accomplished by adding a process agent to the premix, specifically before the second mixing step, in other words at the end of the first mixing step or after the first mixing step. Considered as a process agent for the purposes of this invention is any auxiliary which is added to the premix but does not directly cause its chemical modification and in particular is not suitable as a solvent of the base component of the adhesive. Moreover, the auxiliary must not remain in the adhesive and is therefore no longer present in the end product.

Through the addition of the auxiliary the premix is quenched, with the consequence that this premix, immediately before the beginning of the second mixing step, has a lower material temperature than in the first mixing step. “Quenching” for the purposes of the invention refers to a heat treatment of the premix in the course of which the premix is suddenly cooled. Particularly intensive cooling of this kind is achieved in accordance with the invention by exploiting a phase transition that occurs in the process agent at corresponding temperatures. Typically this is an evaporation process, in the course of which the process agent undergoes a sudden conversion from the liquid aggregate state into the gaseous aggregate state. The energy needed for the phase transition (corresponding to the enthalpy of evaporation or heat of evaporation) is removed from the hot premix in the form of thermal energy, with the consequence that the premix undergoes an overall cooling.

If in this case the evaporated process agent is removed from the adhesive in a devolatilization process, it is ensured, furthermore, that the thermal energy transferred as heat of evaporation is not introduced back into the premix in the case of condensation of the process agent.

The process agent therefore permits rapid and at the same time highly efficient and intense cooling of the adhesive. Hence the inventors, in the course of extensive series of experiments on the preparation of natural-rubber-based adhesives, surprisingly found that, following the addition of water as a process agent, it is possible to obtain, at the exit die of a planetary roller extruder, an adhesive temperature which is lower by 90° C. than the exit temperature measured without the use of a process agent, with homogeneous adhesives being obtained even at the lower temperature. With a low temperature of this kind in the second mixing step it is reliably ensured that no more than slight breakdown of the elastomer, at most, can occur. The addition of such a process agent, accordingly, results in a sudden increase in the viscosity of the premix, thereby making possible the preparation of high-cohesion PSAs—those based on natural rubbers, for example.

Moreover, under the prevailing operating conditions, the process agent takes the form of a gas, after cooling, and can be removed from the premix in a simple way. As a result, not only is continuous removal of heat possible, through the diversion of the heated gas, but at the same time it is also ensured that there are no residues of the process agent remaining in the end product, i.e. in the completed adhesive coating.

When a planetary roller extruder is used as a mixing assembly, the evaporated process agent can advantageously be removed by way of backwards venting through the planetary roller extruder. As a result of the hold up of material ahead of the exit die of the extruder, the internal pressure of the adhesive rises within the extruder towards the exit die. On the basis of this pressure gradient along the mixing path, the gaseous (and hence highly mobile) evaporated process agent is transported against the direction of material conveyance towards the intake zone of the planetary roller extruder, where it can escape from the extruder. In this way, there is no need for separate venting means on the mixing assembly, thereby opening up the possibility of particularly compact construction of the mixing assembly. Any slight residues of the process agent that are included in the material escape, finally, on exit from the die and also on application of the adhesive to the substrate or carrier.

In order to obtain such intense cooling it is necessary for the boiling temperature of the process agent to be lower than the first assembly temperature (or, at least, than the temperature of the premix material that comes about at the first assembly temperature).

Instead of the phase transition from the liquid to the gaseous state it is also possible, in accordance with the invention, of course to use all other phase transitions with which the process agent removes thermal energy from the premix: for example, a transformation from one solid phase into another solid phase, or the sublimation of a solid process agent. Furthermore, it is also possible in principle, in accordance with the invention, to use multiple phase transitions: for example, from the solid to the liquid state and subsequently from the liquid to the gaseous state, so that, for instance, cooling through addition of crushed ice is a further possibility. In these cases, the “boiling temperature” would have to be interpreted, in the sense of the invention, as the corresponding temperature at which the phase transformation or phase transition occurs: in other words, for example, the sublimation temperature or the melting temperature.

As process agents it is possible in principle to use all suitable substances which are readily evaporable under the abovementioned operating conditions. It is of practical significance if these substances are chemically inert towards the premix, so that they do not alter the chemical composition of the premix. In view of the high temperatures generally necessary for the process regime, moreover, it may be sensible for the process agent itself to be incombustible and not to maintain combustion reactions, in order thus to reduce any risk of explosion and risk of fire. All of these preconditions, and also further requirements with respect to the environmental compatibility of the overall process, are met in a particular way by water, which may therefore be mentioned in first place as a process agent. At lower operating temperatures or else in an oxygen-free environment, moreover, there may also be other process agents used, examples being short-chain to medium-chain alkanes, alcohols and the like, provided that they do not dissolve the base component of the adhesive or cause it to swell.

It is particularly beneficial if the process agent on addition has a process-agent temperature which is selected from a range from 0° C. to +25° C. Adding a process agent which is cold in relation to the temperature of the material further improves the cooling action of the process agent on its addition, and so in this way the premix can be quenched with particular rapidity. The process agent can also be added in solid form to the premix—in the form of ice, for example.

It is advantageous, furthermore, if the process agent is added to the premix in a fraction of not more than 20% by weight, preferably in a fraction of at least 3% by weight and not more than 10% by weight. If the amounts of process agent are smaller, the cooling effect overall is slight, and so the occurrence of degradation is not effectively prevented. If, on the other hand, the fraction of process agent exceeds 20% by weight, then greasy concretions are observed in the adhesive. The consequence of that is that the shearing force required for intense mixing is not developed, and so the adhesive is no longer fully homogenized. Furthermore, with such large amounts of evaporated process agent, there are severe inhomogeneities of material within the mixing assembly, as a result of which the mixing assembly is subjected in alternation to high mechanical loads, which may even cause damage to it. Furthermore, an inhomogeneously greasy material of this kind cannot be applied as an adhesive coating, or can be so applied only with a high level of cost and complexity of apparatus.

All in all, then, the process of the invention offers the advantage that adhesives with high viscosity can be produced in a gentle way without further thermal, or at least thermally induced, breakdown or degradation. In this way it is also possible in an oxygen-containing atmosphere—under air, for example—to produce adhesives having viscosities of a kind which would otherwise be realizable only by inertization with nitrogen.

As a result of the fact that, using the invention, it is possible to achieve a drastic reduction in the temperature of the material, it is now also possible in the process of the invention to use non-temperature-resistant adjuvants, which exhibit an increased susceptibility to relatively high temperatures; examples include volatile, thermally decomposable or reactive substances such as crosslinkers, fragrances or foaming agents, for instance. With conventional solvent-free preparation of non-thermoplastic PSAs with elastomers, in contrast, it is not possible to do this.

Non-temperature-resistant adjuvants of this kind can be added to the PSA as early as before the first mixing step, during the first mixing step, or between the first mixing step and the second mixing step; for particular applications, their introduction even not until after the second mixing step is an option.

It is particularly advantageous to use a crosslinker agent as an adjuvant. This makes it possible for the adhesive, after blending and application to a substrate, to be finally aftercrosslinked, thereby further enhancing the already high level of cohesion of the adhesive.

As crosslinker agents (crosslinking agents) it is possible in principle to use all suitable chemically and/or physically crosslinking systems, examples being crosslinkers or crosslinker components (i.e. substances which, as components of a crosslinker system, result in crosslinking together with further components of the crosslinker system; besides crosslinking multi-component systems, these include, for example, crosslinking catalysts, crosslinking accelerants, crosslinking initiators and the like). Suitable crosslinker agents conventionally develop crosslinking only after initiation: for example, at relatively high temperatures, on exposure to high-energy light such as ultra-violet light, for instance, or with another form of high-energy radiation, such as electron beams, for instance. This crosslinking is retained after the initiation.

As crosslinker agents that are suitable for thermally induced chemical crosslinking it is possible for instance to use all known thermally activable chemical crosslinker systems, examples being accelerated sulphur systems or sulphur donor systems, isocyanate systems, reactive melamine resin systems, formaldehyde resin systems, phenol-formaldehyde resin systems (which optionally may be halogenated), epoxidized polyester resin systems and acrylate resin systems or combinations thereof, and also reactive phenolic resin systems or diisocyanate crosslinking systems, which can be used with the corresponding activators as crosslinker components. Thermal initiation is typically carried out at temperatures above 50° C., preferably at temperatures in a range from 90° C. to 160° C., more preferably at temperatures of at least 110° C. and not more than 140° C.

It is particularly beneficial here for the crosslinker agent not to be added until after the process agent has been added. It may be added, for example, immediately after the addition of the process agent, not until the second mixing step, or not until after that, even—in a further mixing step, for instance. As a result of the addition of the crosslinker agent only after the quenching of the premix, the crosslinker agent is not exposed to the relatively high material temperatures that occur in the first mixing step, and so premature and hence unwanted initiation of crosslinking is avoided and it is possible to obtain optimum utilization of the crosslinking capacities of the added crosslinker agent.

The problem on which the invention is based can therefore be solved through the use of water for the spontaneous cooling of a pressure-sensitive adhesive comprising not-exclusively-thermoplastic constituents with at least one elastomer in a planetary roller extruder in the case of direct addition of the water to the PSA between two processing steps within the planetary roller extruder. The spontaneous cooling, i.e. the provision of a cooling performance which is high for at least a short time, is achieved in a particularly intensive way which is therefore also gentle to the adhesive in the case where water is used as a process agent for quenching. This is of advantage more particularly, in the case of PSAs containing not-exclusively-thermoplastic constituents, in order to preserve elastomers that are present therein, such as high molecular mass rubbers, for example natural rubbers, from breakdown processes. As a result of the direct addition of the water to the mixing assembly, the possibility is afforded of rapid cooling of the adhesive between two processing steps without the occurrence of any notable degradation of the adhesive.

A further problem addressed by the invention was that of providing a high-cohesion PSA with at least one not-exclusively-thermoplastic elastomer that has a high viscosity even without aftercrosslinking. Since comparable adhesives from conventional processes are subject to severe degradation, the elastomer networks in conventional adhesives undergo partial thermal breakdown, and so, in addition to short-chain polymers, the low molecular mass breakdown products of these polymers are also encountered in the adhesive. These products may significantly reduce the ageing stability of the adhesives. It has been possible to solve this problem with an adhesive which is preparable by the process described above and with which adhesives are obtained whose elastomer fraction has a greater average chain length than it has been possible to date to obtain by conventional processes, and from which thermal breakdown products of the elastomer chains are also absent—or, at most, present to a negligibly small extent.

A final problem addressed by the invention was that of providing a substantially two-dimensional element (“2D element”) having pressure-sensitive adhesion properties and possessing ready redetachability. The 2D element for the purposes of this specification is any customary, suitable structure having a substantially two-dimensional extent. Moreover, they permit adhesive bonding and may take a variety of forms, more particularly flexible forms, such as an adhesive sheet, adhesive tape, adhesive label or diecut. Pressure-sensitively adhesive 2D elements are 2D elements which can be bonded adhesively under just a gentle applied pressure and redetached from the substrate without residue. For this purpose, the 2D element is provided on one or both sides with adhesives, the adhesives being identical or different. The 2D element may have a carrier or may be of carrier-free design, taking the form of an adhesive transfer tape, for instance. In accordance with the invention the pressure-sensitively adhesive 2D element features the above-described high-cohesion PSA that contains at most a small fraction of thermal breakdown products. This 2D element can be produced using any of the known, suitable shaping methods for an adhesive coating and also corresponding coating processes.

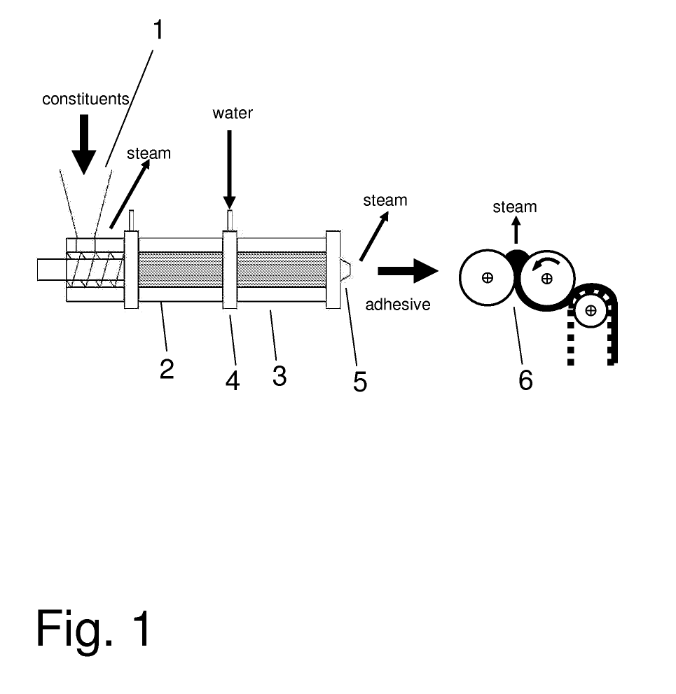

Further advantages and possible applications will become apparent from the exemplary embodiments below, which are described in more detail with reference to the attached drawing. In that drawing, FIG. 1 shows, diagrammatically, the production of a pressure-sensitively adhesive 2D structure using a planetary roller extruder.

As planetary roller extruders it is possible in principle to use all planetary roller extruders having a plurality of mixing zones. In the case of the extruder shown in FIG. 1 there are two mixing zones depicted. Instead, however, the extruder may also possess further mixing zones and/or transport zones, in order thus to allow graduated compounding. In the filling section 1 the constituents of the PSA are introduced into the extruder; in the present case, they are granulated rubber, tackifier resins and fillers. In the roller cylinder of the first mixing zone 2 the first mixing step takes place. Here the rubber granules, the resins and the fillers are broken down and conveyed as a premix from the first mixing zone 2. As a consequence of the high level of internal friction, adhesive temperatures of more than 200° C. may come about in the first mixing zone.

The second mixing zone 3 follows the first mixing zone 2 via a connecting element 4. In the connecting element 4, 3%-10% by weight of water as a process agent is added to the premix. As a result of the high temperature of the premix material, the water evaporates immediately on its addition, and so the premix undergoes sudden cooling. The water vapour that is formed in this process is removed from the interior of the extruder via backwards venting through the first mixing zone 2 and via the filling section 1.

The now-cooled premix is conveyed into the roller cylinder of the second mixing zone 3, where it is homogenized in the second mixing step. At the end of the second mixing zone 3, the adhesive is conveyed from the extruder via the exit die 5 and is transferred to a roll applicator 6. In the roll applicator 6 the adhesive is applied to a temporary carrier (referred to as a process liner) and is then joined to a carrier film as a permanent carrier. Residual water present in the adhesive is removed from the adhesive on its exit from the exit die 5 or evaporates at the heated entry slot of the roll applicator 6.

The advantageous effect of the invention is illustrated below using an example formula which corresponds to an arbitrarily selected, typical adhesive composition.

The adhesive contained 40% by weight of a natural rubber (TSR 3L from Weber & Schaer), 40% by weight of a hydrocarbon resin (Piccotac 1100E from Eastman Chemicals, with a melting point of about +100° C.), 19% by weight of calcium carbonate (Mikrosöhl 40 from Vereinigte Kreidewerke Damman) as filler and 1% by weight of a sterically hindered phenol as antioxidant (Irganox 1076 from Ciba Geigy).

In this case the process of the invention was carried out using a planetary roller extruder having the basic construction shown in FIG. 1. With the formula the same in each case, and under otherwise constant conditions, the planetary roller extruder was operated under air and under a nitrogen atmosphere.

The first assembly temperature of the roller cylinder in the first mixing zone was set at 80° C., and the second assembly temperature of the roller cylinder of the second mixing zone was set at 90° C. To quench the adhesive composition it was admixed in each case with liquid water as a process agent. The throughput of the planetary roller extruder was set at 20 kg/h for a rotary speed of 90 min⁻¹.

In the roller cylinder of a first mixing region of a planetary roller extruder, the constituents were mixed to form a premix, which was transferred from there into the roller cylinder of the second mixing region, for concluding homogenization. As a process agent, different amounts of water were added to the premix. Measurements were carried out in each case under oxygen-containing conditions and oxygen-free conditions.

Parameters measured for the respective operating regime were the temperature of the adhesive at the exit of the extruder and also the viscosity of the adhesive. The viscosity measurement was carried out as a determination of the dynamic viscosity by means of an oscillation viscometer (RPA 2000 from Alpha Technologies) with an oscillation frequency of 0.1 rad/s and an oscillation amplitude of 10° for a sample volume of approximately 4.5 cm³. For the results to be comparable, the measurements were conducted in each case at identical adhesive temperatures of 110° C.

The results of this series of experiments are set out in Table 1 for the measurements in air and in Table 2 for the measurements taken in a nitrogen atmosphere.

TABLE 1

| | | | |
|---|---|---|---|
| Addition of water | 0 | 5 | 10 |
| [% by weight] | | | |
| Atmosphere | air | air | air |
| Viscosity | 120 000 | 240 000 | 270 000 |
| [Pa * s] | | | |
| Exit temperature | 120 | 110 | 110 |
| [° C.] | | | |

TABLE 2

| | | | |
|---|---|---|---|
| Addition of water | 0 | 5 | 10 |
| [% by weight] | | | |
| Atmosphere | nitrogen | nitrogen | nitrogen |
| Viscosity | 220 000 | 320 000 | 330 000 |
| [Pa * s] | | | |
| Exit temperature | 140 | 115 | 110 |
| [° C.] | | | |

The viscosities measured under nitrogen were significantly higher in all cases than the corresponding viscosities under air. The reason for this is that, under nitrogen, the breakdown in the adhesive is lower, and so there is no significant reduction in the average chain length of the polymers present in the adhesive, and hence, in addition, the viscosities measured remain high. The exit temperatures are similar for the measurements under nitrogen and under air, with the figures determined under nitrogen tending to come out slightly larger than the corresponding values measured under air.

Both for the measurements in air and for the measurements under nitrogen it is apparent that an addition of just 5% by weight results in a large increase in the viscosity. In the case of the system investigated here, this is accompanied by a small decrease in the exit temperature (the decrease in the exit temperature as a function of the polymer selected as base component and also as a function of the further composition of the mixture may also be substantially greater for other systems). In this case the viscosity determined in air is higher than the viscosity determined under nitrogen for a water content of 0% by weight. A smaller increase in viscosity is observed (not shown) if, instead, smaller amounts of water are added, only 1% by weight for example.

On addition of 10% by weight of water or more, there is only a slight additional increase in the change in the viscosity—as compared with the viscosity change on switching from 0% by weight water to 5% by weight water, whereas the exit temperatures do not show any significant change. Moreover, the difference between the respective measurements determined in air and the measurements determined under nitrogen when at least 10% by weight of water is added is much smaller than when only 5% by weight of water is added.

The results suggest that with the process of the invention it is possible, with addition only of a small amount of process agent, to obtain high-viscosity PSAs on the basis of not-exclusively-thermoplastic elastomers even without the use of additional solvents or thermoplastic additives. Such a small amount of process agent, moreover, offers the advantage that it can easily be removed again from the system. Where, furthermore, the quenching is associated with inertization, it is possible to prepare adhesives with a viscosity which it was hitherto impossible to achieve in comparable processes. In the case of the mixture used, a further increase in the amount of water added did not result in any further significant increase in the viscosity of the adhesive.

1. Process for preparing a high-cohesion non-thermoplastic pressure-sensitive adhesive (PSA) comprising:
mixing, in a first mixing step, constituents of the PSA comprising at least one elastomer by means of a first mixing assembly, at a first assembly temperature of the first mixing assembly, to give a premix and
homogeneously mixing, in a second mixing step, constituents of the premix by means of a second mixing assembly, at a second assembly temperature of the second mixing assembly,
wherein the first assembly temperature and the temperature of the premix at the first assembly temperature are higher than the second assembly temperature, and in that
between the first mixing step and the second mixing step the premix is quenched by the addition thereto of a process agent whose boiling temperature is lower than the first assembly temperature.

2. Process according to claim 1, wherein the first assembly temperature is selected from a range from +130° C. to +180° C. and the second assembly temperature is selected from a range from +70° C. to +140° C.

3. Process according to claim 1 wherein water is used as process agent.

4. Process according to claim 1, wherein the process agent is added to the premix in a fraction of not more than 20% by weight.

5. Process according to claim 1, wherein the process agent on addition has a process agent temperature selected from a range from 0° C. to +25° C.

6. Process according to claim 1, wherein the second mixing assembly is an extruder.

7. Process according to claim 1, wherein the first mixing assembly is an extruder.

8. Process according to claim 7, which produces vaporized process agent, and the vaporized process agent is removed via backwards venting through the extruder.

9. Process according to claim 1, wherein a non-temperature-resistant adjuvant is added after the addition of the process agent.

10. A method for the spontaneous cooling of a pressure-sensitive adhesive (PSA) comprising not-exclusively-thermoplastic constituents with at least one elastomer in a planetary roller extruder, said process comprising directly adding water to the PSA between two processing steps within the planetary roller extruder.

11. High-cohesion pressure-sensitive adhesive (PSA) with at least one not-exclusively-thermoplastic elastomer, obtainable in a process according to claim 1.

12. High-cohesion pressure-sensitive adhesive according to claim 11, wherein the at least one not-exclusively-thermoplastic elastomer comprises at least one rubber as non-thermoplastic elastomer, selected from the group consisting of natural rubbers and synthetic rubbers.

13. Pressure-sensitively adhesive, substantially two-dimensional element comprising a high-cohesion pressure-sensitive adhesive according to claim 11.
